(19) United States
(12) Patent Application Publication
(10) Pub. No.: US 2018/0100549 A1
(43) Pub. Date: Apr. 12, 2018

(54) APPARATUS FOR SECURING A COUPLED ELEMENT TO A SHAFT

(71) Applicant: Holmes Solutions Limited Partnership, Wellington (NZ)

(72) Inventors: John McCALLISTER, Christchurch (NZ); Mark THOMSON, Christchurch (NZ); Murray AITKEN, Christchurch (NZ); Stuart CLARK, Christchurch (NZ)

(73) Assignee: Holmes Solutions Limited Partnership, Wellington (NZ)

(21) Appl. No.: 15/559,008

(22) PCT Filed: Mar. 15, 2016
(86) PCT No.: PCT/NZ2016/050039

§ 371 Date: Sep. 15, 2017

(30) Foreign Application Priority Data
Mar. 15, 2015 (NZ) 705514

(51) Int. Cl. F16D 1/09; F16D 1/05

(52) U.S. Cl. CPC F16D 1/09; F16J 1/12; F16D 1/05

(57) ABSTRACT

Described herein is an apparatus for securing a coupled element onto a shaft. More particularly, an apparatus is described that provides a tight fitment of a coupled element such as a piston onto a shaft capable of handling high pressure forces without relative movement of the coupled components and, which may minimise parts needed, provide optimal material utilisation, and avoid the requirement for fasteners.

### RELATED APPLICATIONS

This application derives priority from New Zealand patent application number 705514 incorporated herein by reference.

### TECHNICAL FIELD

Described herein is an apparatus for securing a coupled element onto a shaft. More particularly, an apparatus is described that provides a tight fitment of at least one coupled element, such as a piston, onto a shaft capable of handling high transferred forces without relative movement of the coupled components. The apparatus may minimise parts needed, provide optimal material utilisation, and avoid the requirement for fasteners.

### BACKGROUND ART

Shafts are widely used in mechanical structures for a wide array of apparatus. A shaft for the purposes of this specification refers to a rod or tube that moves along a set path, movement being either rotation, oscillation, linear and/or angular movement. Shaft movement may drive a mechanical element such as a piston and the piston is linked to the shaft in order to maintain a constant fixed relationship between the piston and shaft.

Achieving this linkage at a point along a shaft can be challenging since the coupled element such as a piston needs to engage the shaft that, in use, may move rapidly, accelerate or decelerate rapidly, and may move with significant force/torque. In addition, the movement and force may need to be transferred to the piston with no movement between the shaft and piston. One art embodiment of a single shaft embodiment uses a larger shoulder integrated into the shaft (the piston is integral to the shaft) or a fused or bonded coupled between the shaft and piston. These approaches are not ideal since they increase the apparatus complexity and can introduce localised stresses in the materials.

For similar reasons to the above, linking two separate shafts (a master and slave arrangement for example), may also be difficult to achieve and avoid slippage between the two shafts.

One solution to couple two shafts is disclosed in U.S. Pat. No. 4,134,699 comprising a sleeve having a passage adapted to receive the end portions of two aligned shafts, an outer circumferential surface having two axially spaced sections which conically diverge towards each other, and a radial flange intermediate the sections; a pair of pressure rings each surrounding one of the sections and having a conically tapering inner circumferential surface complementary to the respectively surrounded section; and bolts connecting the pressure rings with the flange and operative for pulling the pressure rings axially towards each other and towards the flange to thereby compress the sleeve radially inward into frictional engagement with shaft end portions located in the passage.

U.S. Pat. No. 3,782,841 discloses an apparatus for securing an annular member to a shaft for torque transmission therebetween by a hub sleeve having an internally smooth, circumferentially continuous non split configuration adapted to fit smoothly over the shaft. A double compression ring is seated on the sleeve and is elastically compressible. The compression ring is clamped between a pair of annular thrust rings provided with equispaced bores through which bolts are threaded to draw the thrust rings together and urge the sleeve under radial compression against the shaft.

The above solutions have the draw back of requiring the use of fasteners to fix a coupled element to a shaft or shafts. Fasteners are not always practical or desirable when the coupled element is a piston since:
Inserting holes for fasteners into the shaft may weaken the shaft structure;
The gap around fasteners may provide a means for egress of debris and/or fluids leading to contamination, fluid retention and build up, and the potential for corrosion and/or microbial formation around build up areas;
Fasteners can be slow to fix in place and remove thereby increasing the labour involved around manufacture and servicing; and
Fasteners can work loose during operation meaning more regular servicing than might the case through other modes of linkage.

U.S. Pat. No. 4,815,360 discloses a rod-connection that utilises a split ring, having two or more segments, provided with a plurality of shallow internal grooves which are adapted to mate with corresponding plurality of shallow grooves on the piston rod, the outer periphery of the split ring having a tapered surface extending over the entire width of the split ring and adapted to mate with a corresponding wide tapered surface defined in a bore of a compression bushing which has a peripheral surface provided with threads which engage with an internal threaded surface in a cavity in the piston. By applying a threading torque to the compression sleeve, a force is generated by the two tapered surfaces to force the sleeve into better contact with the piston and to force the split ring into a better contact with the piston rod.

With regards integrated shaft shoulders, grooved or threaded surfaces and forged or machined components or the like, these techniques require custom shaft design and inevitably introduce significant stress concentrations and material inefficiencies. In addition, threaded and fused or bonded couplings can have high process variability resulting in bulky constructions.

It should be appreciated that it may be advantageous to provide a coupling apparatus to secure mechanical elements to a shaft that may be robust and able to withstand high pressure forces or at least to provide the public with an alternative choice to couple elements together.

Further aspects and advantages of the apparatus will become apparent from the ensuing description that is given by way of example only.

### SUMMARY

Described herein is an apparatus with an attachment connection for securing a coupled element onto a shaft, the attachment connection being capable of handling very high forces and preventing relative movement between the coupled element and shaft. The design may also minimise parts needed, provide optimal material utilisation, plus the design avoids the need for fastener use.

In a first aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
   (a) a clamping force imposed by the at least one coupled element on the shaft due to an imposed interference fit between at least part of the at least one coupled element and the shaft; and
   (b) a friction effect due to clamping about at least part of the at least one coupled element and the shaft facing surfaces.

In a second aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element coupling completed by a combination of:
   (a) a clamping force imposed by the at least one coupled element on the shaft due to an imposed interference fit between at least part of the at least one coupled element and the shaft; and
   (b) keying between the at least one coupled element and the shaft about at least part of the at least one coupled element and the shaft facing surfaces.

In a third aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
   (a) a clamping force imposed by at least one clamping member applying an external load on the at least one coupled element such that the at least one coupled element has an imposed interference fit between at least part of the at least one coupled element and the shaft; and
   (b) a friction effect due to clamping about at least part of the at least one coupled element and the shaft facing surfaces.

In a fourth aspect, there is provided a method of coupling a shaft and at least one coupled element by selecting at least one shaft and at least one coupled element and coupling the shaft and element or elements using the apparatus substantially as described above.

Advantages of the above described apparatus comprise the provision of a connection that is robust and capable of handling significant forces while avoiding slippage or decoupling. The design avoids the need to use fasteners and therefore avoids art issues associated with fasteners. The design also is able to be achieved through a small number of relatively easy to manufacture parts. Further advantages are described below.

### BRIEF DESCRIPTION OF THE DRAWINGS

Further aspects of the apparatus will become apparent from the following description that is given by way of example only and with reference to the accompanying drawings in which:

FIG. 1 illustrates a schematic perspective cross-sectional view of a piston and shaft joint with a continuous shaft;

FIG. 2 illustrates a schematic cross-sectional side view of a piston and shaft joint with a master and slave shaft, the piston linking the two endings of the shaft; and

FIGS. 3a and 3b illustrates side cross-section views of alternative part arrangements.

### DETAILED DESCRIPTION

As noted above, described herein is an apparatus with an attachment connection for securing a coupled element onto a shaft, the attachment connection being capable of handling very high transferred forces and preventing relative movement between the coupled element and shaft. The design may also minimise parts needed, provide optimal material utilisation, plus the design avoids the need for fastener use.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

The term ‘viscous damper’ or grammatical variations thereof refers to a device that offers resistance to motion achieved predominantly through the use of viscous drag behaviours, such that energy is transferred when the damper undergoes motion. Although viscous drag behaviours are noted here, those skilled in the art will appreciate that other methods are possible and as such, this definition should not be seen as limiting. It may be used in applications where impact damping or oscillatory damping is beneficial.

The term ‘hydraulic cylinder’ or grammatical variations thereof refers to a device that imposes a coupling force between members within a cylinder at least partially via one or more hydraulic forces.

The term ‘cylinder’ or grammatical variations thereof as used herein refers to a cylinder with a bore therein along the longitudinal axis of the cylinder.

The term ‘fastener’ or grammatical variations thereof as used herein refers to a mechanical fastener that joins or affixes two or more objects together. As used herein, this term excludes simple abutting or facing of materials and typically refers to a part or parts joining or affixing through obstruction. Non-limiting examples of fasteners include screws, bolts, nails, clips, dowels, cam locks, rope, string or wire.

The term ‘elastic displacement’ or grammatical variations thereof refers to a materials resistance to being displaced in shape elastically (i.e. non-permanently) when a force is applied to it and the ability of the material to recover this displacement when the force is removed. The modulus of elasticity of a material is defined as the slope of its stress-strain curve in the elastic displacement or deformation region.

The term ‘fits with interference’ or grammatical variations thereof refers to a connection between parts that is achieved by clamping pressure generated as the result of elastic displacement of the a part or parts when the part or parts undergo imposed dimensional change after the parts are overlaid together, rather than by any other means of fastening.

The terms ‘fits with friction’, ‘friction force’, ‘friction effect’, ‘friction fit’ or grammatical variations thereof refer to the face of the shaft and the face of the coupled element being frictionally held together, the connection made as a result of both interface pressure and the friction force resulting from the interface pressure.

The term ‘seal’ or grammatical variations thereof refers to a device or arrangement of features acting to form a barrier between two fluid volumes.

In a first aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
   (a) a clamping force imposed by the at least one coupled element on the shaft due to an imposed interference fit between at least part of the at least one coupled element and the shaft; and
   (b) a friction effect due to clamping about at least part of the at least one coupled element and the shaft facing surfaces.

The apparatus described above may for example provide a simple method for attaching a coupled element (such as a piston) to a shaft (such as a piston rod) for load transfer in a device whilst simultaneously maintaining a high degree of concentric alignment between the coupled element and the shaft.

The friction fit may be achieved through selection of at least one material at the facing surface or surfaces with a coefficient of friction sufficient to at least partially resist relative movement between the shaft and/or the at least one coupled element. Further, the friction fit may be achieved and/or enhanced via selection of materials and/or finishing techniques on the facing surface or surfaces about part or all of the coupled element and shaft abutting surfaces. Finishing techniques may be selected from: roughening the surface, use of friction enhancing features on the material surfaces, and combinations thereof.

Interference or friction fitting as noted above may have the advantage of allowing concentricity between the coupled element and shaft to be tightly controlled unlike art methods utilising fasteners or other connection means.

In a second aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element coupling completed by a combination of:
   (a) a clamping force imposed by the at least one coupled element on the shaft due to an imposed interference fit between at least part of the at least one coupled element and the shaft; and
   (b) keying between the at least one coupled element and the shaft about at least part of the at least one coupled element and the shaft facing surfaces.

Keying as noted above may occur between at least one extension member from either the shaft or the at least one coupled element mating with at least one complementary recess in the shaft or the at least one coupled element and, once mated, the at least one extension member and at least one recess interlock to prevent relative movement between the shaft and at least one coupled element.

The at least one extension member and/or the at least one recess noted above may be pre-formed in the shaft and at least one coupled element prior to coupling.

The at least one extension member and/or the at least one recess noted above may be formed by elastic displacement, plastic deformation or a combination of elastic and plastic displacement/deformation of a part or all of the at least one coupled element and/or shaft as the shaft and the at least one coupled element are mated together.

The at least one coupled element may be fitted to the shaft with at least a component of elastic displacement. Fitting may be via completely elastic displacement or a mixture of elastic displacement and some plastic (non-elastic) deformation. As noted above, displacements may be deliberately imposed on the components to utilise their elasticity to provide the clamped pressure. This may be achieved in part by choice of material—for example, the material used for either the shaft or coupled element or both may have some elasticity and/or ability to deform and, in this manner, couple together.

Note that interference fitting and friction fitting differ to ‘sliding fitting’ where the sliding element slides over the shaft and then is fixed in place via at least one additional element and not by friction or an interference fit.

The materials used to form the shaft, at least one coupled element, or both, may have sufficient elasticity to elastically displace during coupling and substantially not undergo plastic deformation for at least the degree of deformation needed to generate the clamping force between the at least one coupled element to the shaft.

The shaft may comprise a longitudinal axis and a cross-section shape selected from: square, oblong, elliptical, circular, spline, gear forms, polygonal shapes. This should not be seen as limiting as the shape may be varied yet still achieve the above described function.

The shaft may in one embodiment be a solid rod. The shaft may alternatively be an at least partly hollow tube. For strength and structural integrity it is anticipated that the shaft may be a substantially solid rod. However, the coupled element may be used for hollow rods as well subject to use of correct clamping force so as not to cause deform, displace or otherwise alter a part or all of the hollow tube.

On application of a driving force, the shaft may move:
(a) rotationally about a longitudinal axis and transfers rotational force to the at least one coupled element;
(b) axially along the longitudinal axis and transfers the axial movement to the at least one coupled element.

The driving force may be a substantially rotational force (a torque), a substantially pressure force (a pressure—ie force distributed over an area), and/or a substantially linear force (a force). Combinations of these forces may also be used.

The shaft may be continuous about the coupled element region of the shaft. In this embodiment, the at least one coupled element may be located at any point along the shaft length.

The at least one coupled element may instead act to join the ends of two shafts together, the shaft ends retained in place and operatively linked together about the at least one coupled element. In this embodiment, the at least one coupled element may fit with interference over an end of a first shaft and also over an end of a second shaft and the at least one coupled element acts to transfer a force imposed on the first shaft to the second shaft or vice versa. For example, one shaft may be a master or drive shaft with a driven movement and the coupled element fits with interference over an end of the master shaft and also over an end of a slave shaft and the coupled element acts to transfer a force on the master or drive shaft to the slave shaft. In this way, interference fitting of the coupled element to the shafts ensures accurate shaft alignment in a two piece assembly.

The shaft may have sufficient structural integrity to transfer a force along the shaft length. To achieve the desired degree of structural integrity, the shaft may be manufactured from a metal or metal alloy material although other materials such as fibre composites may also be used depending on the end application.

As may be appreciated from the above, the apparatus construction may provide high structural rigidity particularly in continuous shaft embodiments and better material efficiency than traditional bolted/spigotted connections. The above described design may be particularly beneficial in applications where the shaft undergoes lateral loading although rotational loading is also possible.

In one embodiment, the shaft may be a piston rod.

As noted above, both interference and friction and/or keying may used collectively for coupling.

The attachment clamping force may be sized to provide full axial load force capacity of the coupled element via the interference and/or friction/keying connection. Sizing of the clamping force may be by means of the coefficient of friction between the material combinations, the radial clamping force provided by the interference fit and optionally, a secondary clamping force from at least one additional member, an example being at least one clamping member described further below.

The effect of clamping force may be maximised by the interference/friction fit between the coupled element and shaft, with substantially no additional clamping force being used to take up clearance.

The at least one coupled element may be axially mounted to the shaft. This may be advantageous particularly where the shaft rotates as non-axial mounting of the at least one coupled element may result in damage to the shaft or other elements in the apparatus.

The at least one coupled element or a part thereof may extend around greater than 50, or 55, or 60, or 65, or 70, or 75, or 80, or 85, or 90, or 95% of the shaft exterior surface. The at least one coupled element or a part thereof may extend completely around the shaft exterior surface. The coupled element may have a longitudinal length sized to suit the desired strength needed, the greater the element coupled length, the greater the contact area and hence greater the interference fit between the shaft and coupled element.

The at least one coupled element may have an aperture through which the shaft is placed and the at least one coupled element, in a non-displaced and/or non-deformed state, may have a smaller aperture than the shaft exterior.

The at least one coupled element may comprise an extension from a body portion of at least one coupled element. The extension may be selected from at least one of: a flange, a seal, an arm, a protrusion, a bulk, and combinations thereof. The extension may transfer force from the shaft. Alternatively, the extension may transfer force to the shaft. The extension in one embodiment may be a flange extending about the circumference of the body of the at least one coupled element. The coupled element and flange may be a plunger head or piston head.

The shaft may have a constant width/diameter about the region to which the at least one coupled element is coupled.

Alternatively, the at least one coupled element facing surface that abuts the shaft may have a constant complementary shape relative to the shaft facing surface. In this embodiment, the surfaces may have a continuous or variable width/diameter.

The shaft may have a taper substantially along the shaft longitudinal axis so that the shaft cross-sectional area at one point along the longitudinal axis varies from the shaft cross-sectional area at another point and, the at least one coupled element is fitted about this tapered region. The at least one coupled element may have a tapered facing surface that complements the shaft tapered region. In this taper embodiment, the at least one coupled element may mate with the shaft in a drive-up process, such that, at the point of first overlap of the at least one coupled element and the shaft, the at least one coupled element initially fits over the shaft without interference and, when the at least one coupled element is fully fitted to the taper of the at least shaft, an interference fit results.

The at least one coupled element and/or shaft may be selected to be substantially heat conductive and also may have the properties of:
(a) dimensional expansion rate on heating; and/or
(b) dimensional contraction rate on cooling.

The at least one coupled element and/or shaft may have a heat conductivity of at least or greater than approximately 5 W/(m·K). A potentially beneficial aspect of choosing a high heat transfer material for the coupled element may be the ability to provide a heat sink to dissipate heat from a working fluid such as a hydraulic fluid that the apparatus interacts with. Further, compared to a bolted construction, the interference fitting leads to thermal conduction benefits where heat dissipation is required.

The at least one coupled element may be fitted to the at least one shaft by methods selected from:
(a) heat to expand the at least one coupled element;
(b) cold to decrease the shaft size;
(c) hydrostatic pressure to provide a bearing system between the at least one coupled element and the shaft;
(d) elastic deformation in the at least one coupled element;
(e) elastic deformation in the shaft; and
(f) combinations thereof.

The environment or a part thereof, about the at least one coupled element, may impose a pressure force on the non-shaft-interfacing surface regions of the at least one coupled element thereby increasing the clamping force of the at least one coupled element against the shaft.

In one alternative embodiment, the apparatus may comprise at least one clamping member that applies an external load on the at least one coupled element.

As noted above, the above apparatus may have the additional advantage that the radial clamping force between the at least one coupled element and the shaft may be enhanced via the at least one clamping member. The clamping forces may also seal any internal passages against external leakage.

Dynamic operating pressure within the apparatus acting on the coupled element and/or outer collar(s) may further supplement the static clamping force, increasing joint load capacity in a synchronised manner.

The apparatus may comprise at least one clamping member wherein the at least one clamping member imposes a clamping force on the at least one coupled element and, at least partially indirectly, to the shaft through at least part of the at least one coupled element and shaft abutting surfaces.

Coupling may be imposed by a first and second clamping force, the first clamping force on the shaft being provided by a primary interference fit between the at least one coupled element and the shaft and, the second clamping force being provided by a secondary interference fit between the at least one clamping member and the at least one coupled element.

Coupling may also be provided by a friction fit between the at least one clamping member and the at least one coupled element.

The at least one clamping member or a part thereof may extend around greater than 50%, or 60%, or 70%, or 80%, or 90%, or 95%, or 96%, or 97%, or 98%, or 99% of the at least one coupled element. The at least one clamping member or a part of may extend completely around the coupled element circumference.

The at least one coupled element may have a taper shaped non-shaft facing surface. The at least one coupled element taper may extend from a first side of the at least one coupled element longitudinally towards the at least one coupled element centre and/or opposing second side transitioning to a larger cross-section area from the first side to the centre and/or second side of the at least one coupled element. The taper on the at least one coupled element may be axially aligned with the shaft axis.

The at least one clamping member may have an internal taper facing surface substantially similar to the taper of the coupled element. The internal taper facing surface of the at least one clamping member may mate with the at least one coupled element in a drive up process such that, at the point of first overlap of the at least one clamping member and the at least one coupled element, the at least one clamping member initially fits over the at least one coupled element without interference and, when the at least one clamping member is fully fitted to the taper of the at least one coupled element, an interference fit results.

When fitted, the at least one clamping member may provide a static radial clamping force between the at least one coupled element and the shaft. The at least one clamping member may be mated with the at least one coupled element by methods selected from:
(a) heat to expand the at least one clamping member;
(b) cold to decrease the at least one coupled element size;
(c) hydrostatic pressure to provide a bearing system between the at least one coupled element and the shaft;
(d) elastic deformation in the at least one clamping member;
(e) elastic deformation in the at least one coupled element; and
(f) combinations thereof.

The at least one clamping member may be provided with fluid passages to the coupled element/shaft interface to allow the fitting and removal of rings by hydraulic means if required.

The at least one clamping member may in one embodiment be a collar.

The at least one clamping member may be selected to be substantially heat conductive; and to have the properties of:
(a) dimensional expansion rate on heating; and/or
(b) dimensional contraction rate on cooling.

The at least one clamping member may have a heat conductivity of at least or greater than approximately 5 W/(m·K). A potentially beneficial aspect of choosing a high heat transfer material for the at least one clamping member may be the ability to provide a heat sink to dissipate heat from a working fluid such as a hydraulic fluid. Further, compared to a bolted construction, the clamped interference leads to thermal conduction benefits where heat dissipation is required.

The at least one clamping member may be mounted at a point distal to the centre of the coupled element. This may be useful to ensure the coupled element circumference is unaffected by the clamping force.

The environment or a part thereof about the at least one clamping member may impose a pressure force on the at least one clamping member thereby increasing the clamping force of the at least one clamping member against the at least one coupled element.

In a third aspect, there is provided an apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
   (a) a clamping force imposed by at least one clamping member applying an external load on the at least one coupled element such that the at least one coupled element has an imposed interference fit between at least part of the at least one coupled element and the shaft; and
   (b) a friction effect due to clamping about at least part of the at least one coupled element and the shaft facing surfaces.

In a fourth aspect, there is provided a method of coupling a shaft and at least one coupled element by selecting at least one shaft and at least one coupled element and coupling the shaft and element or elements using the apparatus substantially as described above.

In one embodiment, the apparatus may be used in a viscous damper. In this embodiment, the system is a closed system and force is imposed on the rod shaft causing movement of the piston and subsequent dampening of the rod shaft movement caused by transfer in energy from rod shaft kinetic energy to shear force generation and heat energy.

In an alternative embodiment, the apparatus is used in a hydraulic cylinder. In this embodiment, the system is open so that hydraulic fluid for example from an external source may impose a force on the piston and rod shaft inside the cylinder thereby driving movement of the piston and rod shaft within the cylinder.

As may be realised from the above description, the design described does not require the use of fasteners. This design therefore may overcome shortcomings in the art as noted above in the background discussion.

Further advantages of the above described apparatus include those noted in the above discussion and the provision of one or more of the following:
A simple assembly technique to simultaneously provide a means of load transfer and achieve accurate axial alignment between the at least one coupled element and a shaft or two shaft endings;
Static radial clamping forces to seal the at least one coupled element and shaft interface against leakage across the at least one coupled element;
Accurate clamping forces may be achieved by the use of tapers and the assembly techniques described with respect to the shaft/coupled element(s) and, optionally also the coupled element(s) and at least one clamping member;
The design may achieve a high thermal conductivity between the coupled element(s) and the shaft (and at least one clamping member if used) allowing for increased thermal dissipation;
Dynamic hydraulic pressure within the apparatus may provide additional clamping force of the coupled element against the shaft;
The design potentially increases fatigue resistance due to the optimal material usage and lack of fasteners;
High lateral structural rigidity may be achieved particularly in a continuous rod embodiment;
Fewer materials may be needed, particularly compared to traditional bolted/spigoted connections; and
The at least one coupled element circumference may be unaffected by the clamping mechanism.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth,

Where specific integers are mentioned herein which have known equivalents in the art to which this invention relates, such known equivalents are deemed to be incorporated herein as if individually set forth.

### WORKING EXAMPLES

The above described apparatus is now described by reference to specific examples. For ease of reference a shaft and piston application is provided however this should not be seen as limiting since the coupling arrangement described herein may be used in a variety of different applications and not just the piston/shaft coupling noted below.

### Example 1

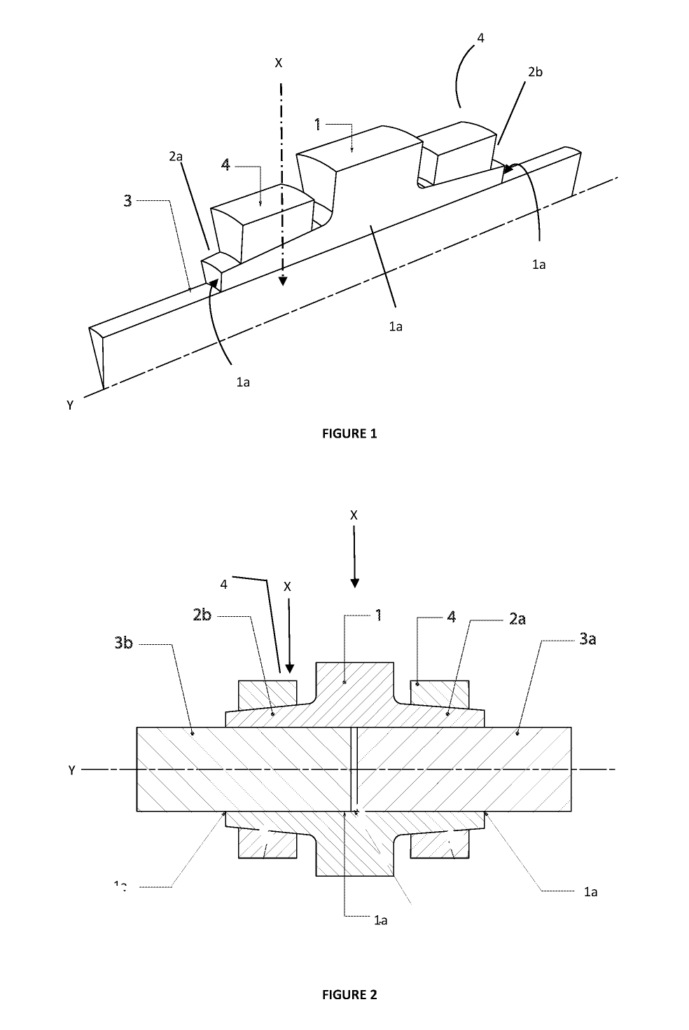

With reference to FIGS. 1 and 2, a coupled element such as a piston 1 is shown attached to a continuous rod or piston shaft 3 housed within a cylinder (not shown).

The apparatus includes a piston 1 incorporating external cones axially tapered at each end 2a,2b, fitted at an interface 1a with interference to the piston shaft 3. Outer clamping members/collars 4 (hereafter termed ‘clamp rings’) are fitted with interference, to provide a static radial clamping force in direction X between the piston 1 and piston shaft 3 towards the shaft longitudinal axis Y. The distal arrangement of the clamp rings 4 to the piston 1 ensures the piston 1 circumference is unaffected by the clamping force. Also, complementary tapered clamp rings 4 provide an additional means to increase the interference between the piston 1 and shaft 3 thereby transferring axial load from the piston 1 to the shaft 3. Note however, that the clamp rings 4 are not essential and can be removed, the piston and shaft 3 being coupled based on interference fitting and friction about the piston 1 and shaft 3 interface 1a.

A frictional connection via a static clamping force additionally allows concentricity between piston 1 and piston shaft 3 to be tightly controlled. The attachment clamping force is sized to provide full axial load capacity of the piston 1 via the friction connection. Sizing of the clamping force is by means of the coefficient of friction between the material combinations, the radial clamping force provided by the primary clamping ring 4, interference connection of the piston 1 and secondary clamping force from the piston 1 to shaft 3 interface 1a.

For applications where high axial load capacity between piston 1 and shaft 3 is required, a continuous shaft 3 embodiment may be useful as illustrated in FIG. 1. An embodiment where the shaft 3 is of a continuous rather than two-piece design facilitates accurate alignment between the shaft 3 and cylinder 7 and between shaft 3 and piston 1. Two piece shaft designs are however possible as illustrated in FIG. 2 where the shaft is formed from two parts 3a, 3b joined about the piston 1.

The effect of the clamping force may be maximised by the frictional connection 1a between the piston 1 and shaft 3, none of the clamping force is being used to take up clearance. Compared to a bolted construction the clamped frictional connection along the piston 1/shaft 3 interface 1a leads to thermal conduction benefits where heat dissipation is required.

The use of tapers 2a, 2b about the clamp ring 4 and piston 1 interface allows accurate setting of the primary interference fit via a drive-up process where the final position of the clamp ring 4 is controlled from the initial zero clearance position. The taper 2a, 2b provides a means for fine adjustment whereby a large axial clamp ring 4 displacement causes a small change in radial interference. A drive-up procedure additionally allows the interference fit between a clamp ring 4 and piston 1 to be set independently of the manufacturing tolerance of the taper 2a, 2b circumferences.

Additional axial force resistance can be achieved by grooving or texturing the shaft 3 surface in a manner that the piston 1 becomes keyed to the shaft 3 under the influence of the clamping forces.

The radial clamping force seals the piston 1/shaft 3 interface 1a against leakage between the two sides of the piston 1. These clamp forces also seal any internal passages (not shown) against external leakage. Dynamic operating pressure within the device, acting on the clamp rings 4 and piston 1, supplement the static clamping force between the piston 1/shaft 3 interface 1a, increasing joint load capacity in a synchronised manner.

The apparatus construction provides high structural rigidity particularly in the continuous shaft 3 embodiment and better material efficiency than traditional bolted/spigoted connections. This construction is particularly beneficial in applications where the shaft 3 undergoes lateral loading.

The clamping rings 4 can be provided with hydraulic passages (not shown) to the piston 1/clamp ring 4 interface to allow the fitting and removal of rings 4 by hydraulic means if required. Alternatively, the rings 4 can be fitted by thermal expansion.

### Example 2

Referring to FIG. 2, a coupled element (as per FIG. 1) such as a piston 1 is shown, but attached to a piston shaft comprising two separate pieces—a master 3a and slave end 3b.

Frictional connection of the piston 1 to the shafts 3a, 3b, ensures accurate shaft alignment in the two piece assembly.

This embodiment with two separate shaft members 3a, includes the same labelled features and operates in the same fashion as described for Example 1 above.

### Example 3

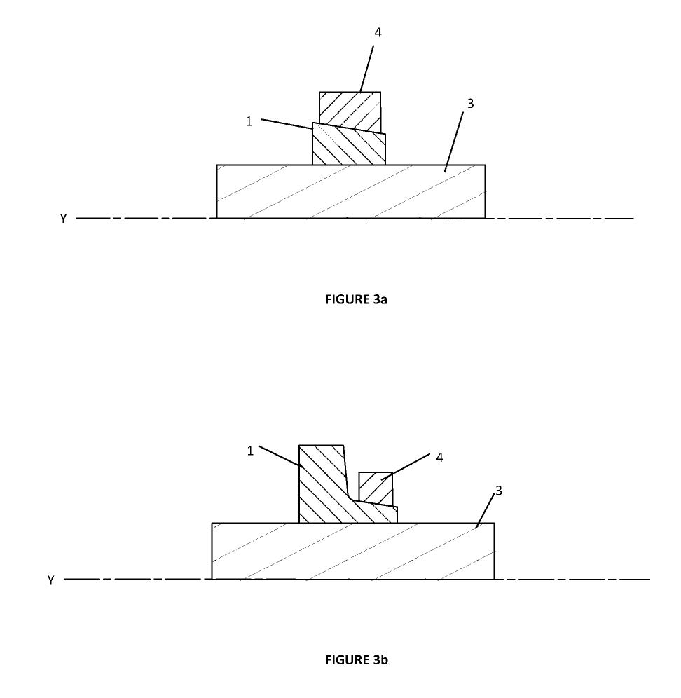

FIGS. 3a and 3b illustrate two alternative piston/shaft/clamping ring embodiments. The Figures show two different approaches on how the parts may inter-relate.

Aspects of the apparatus have been described by way of example only and it should be appreciated that modifications and additions may be made thereto without departing from the scope of the claims herein.

What is claimed is:

1. An apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
(a) a clamping force imposed by the at least one coupled element on the shaft due to an imposed interference fit between at least part of the at least one coupled element and the shaft; and
(b) a friction effect due to clamping about at least part of the at least one coupled element and the shaft facing surfaces.

2. The apparatus as claimed in claim 1 wherein the friction fit is achieved through selection of at least one material at the facing surface or surfaces with a coefficient of friction sufficient to at least partially resist relative movement between the shaft and/or the at least one coupled element.

3. The apparatus as claimed in claim 1 wherein the friction fit is achieved and/or enhanced via selection of materials and/or finishing techniques on the facing surface or surfaces about part or all of the coupled element and shaft abutting surfaces.

4. An apparatus comprising:
a shaft; and
at least one coupled element located about at least a region of the shaft longitudinal length;
wherein the at least one coupled element and the shaft are coupled to prevent relative movement between the shaft and at least one coupled element coupling completed by a combination of:
(a) a clamping force imposed by the at least one coupled element on the shaft due to an imposed interference fit between at least part of the at least one coupled element and the shaft; and
(b) keying between the at least one coupled element and the shaft about at least part of the at least one coupled element and the shaft facing surfaces.

5. The apparatus as claimed in claim 4 wherein keying occurs between at least one extension member from either the shaft or the at least one coupled element mating with at least one complementary recess in the shaft or the at least one coupled element and, once mated, the at least one extension member and at least one recess interlock to prevent relative movement between the shaft and at least one coupled element.

6. The apparatus as claimed in claim 5 wherein the at least one extension member and/or the at least one recess are pre-formed in the shaft and at least one coupled element prior to coupling.

7. The apparatus as claimed in claim 5 wherein the at least one extension member and/or the at least one recess are formed by plastic deformation of a part or all of the at least one coupled element and/or shaft as the shaft and the at least one coupled element are mated together.

8. The apparatus as claimed in any one of the above claims wherein the at least one coupled element is fitted to the shaft with at least a component of elastic displacement.

9. The apparatus as claimed in any one of the above claims wherein the materials used to form the shaft, at least one coupled element, or both, have sufficient elasticity to elastically displace during coupling and substantially not undergo plastic deformation for at least the degree of deformation needed to generate the clamping force between the at least one coupled element to the shaft.

10. The apparatus as claimed in any one of the above claims wherein the shaft comprises a longitudinal axis and a cross-section shape selected from: square, oblong, elliptical, circular, spline, gear forms, polygonal shapes.

11. The apparatus as claimed in any one of the above claims wherein the shaft is a substantially solid rod.

12. The apparatus as claimed in any one of claims 1 to 10 wherein the shaft is an at least partly hollow tube.

13. The apparatus as claimed in any one of the above claims wherein on application of a driving force, the shaft moves:
(a) rotationally about a longitudinal axis and transfers rotational force to the at least one coupled element;
(b) axially along the longitudinal axis and transfers the axial movement to the at least one coupled element.

14. The apparatus as claimed in any one of the above claims wherein the shaft is continuous about the coupled element region of the shaft.

15. The apparatus as claimed in any one of claims 1 to 13 wherein the at least one coupled element acts to join the ends of two shafts together, the shaft ends retained in place and operatively linked together about the at least one coupled element.

16. The apparatus as claimed in claim 15 wherein the at least one coupled element fits with interference over an end of a first shaft and also over an end of a second shaft and the at least one coupled element acts to transfer a force imposed on the first shaft to the second shaft or vice versa.

17. The apparatus as claimed in any one of the above claims wherein the shaft is a piston rod.

18. The apparatus as claimed in any one of the above claims wherein the at least one coupled element is axially mounted to the shaft.

19. The apparatus as claimed in any one of the above claims wherein the at least one coupled element or a part thereof extends around greater than 50% of the shaft exterior surface.

20. The apparatus as claimed in any one of the above claims wherein the at least one coupled element or a part thereof extends completely around the shaft exterior surface.

21. The apparatus as claimed in any one of the above claims wherein the at least one coupled element has an aperture through which the shaft is placed and the at least one coupled element in a non-displaced and/or non-deformed state has a smaller aperture than the shaft exterior surface.

22. The apparatus as claimed in any one of the above claims wherein the at least one coupled element comprises an extension from a body portion of at least one coupled element, the extension selected from at least one of: a flange, a seal, an arm, a protrusion, a bulk, and combinations thereof.

23. The apparatus as claimed in claim 22 wherein the extension transfers force from the shaft.

24. The apparatus as claimed in claim 22 wherein the extension transfers force to the shaft.

25. The apparatus as claimed in any one of claims 21 to 24 wherein the extension is a flange extending about the circumference of the body of the at least one coupled element.

26. The apparatus as claimed in claim 25 wherein the coupled element and flange is a plunger head or piston head.

27. The apparatus as claimed in any one of the above claims wherein the shaft has a constant width/diameter about the region to which the at least one coupled element is coupled.

28. The apparatus as claimed in claim 27 wherein the at least one coupled element facing surface that abuts the shaft has a constant complementary shape relative to the shaft facing surface.

29. The apparatus as claimed in any one of claims 1 to 26 wherein the shaft has a taper substantially along the shaft longitudinal axis so that the shaft cross-sectional area at one point along the longitudinal axis varies from the shaft cross-sectional area at another point and, the at least one coupled element is fitted about this tapered region.

30. The apparatus as claimed in claim 29 wherein the at least one coupled element has a tapered facing surface that complements the shaft tapered region.

31. The apparatus as claimed in claim 29 or claim 30 wherein the at least one coupled element mates with the shaft in a drive-up process, such that, at the point of first overlap of the at least one coupled element and the shaft, the at least one coupled element initially fits over the shaft without interference and, when the at least one coupled element is fully fitted to the taper of the shaft, an interference fit results.

32. The apparatus as claimed in any one of the above claims wherein the at least one coupled element and/or shaft is or are selected to be substantially heat conductive and also have the properties of:
(a) dimensional expansion rate on heating; and/or
(b) dimensional contraction rate on cooling.

33. The apparatus as claimed in any one of the above claims wherein the at least one coupled element is fitted to the at least one shaft by methods selected from:
(a) heat to expand the at least one coupled element;
(b) cold to decrease the shaft size;
(c) hydrostatic pressure to provide a bearing system between the at least one coupled element and the shaft;
(d) elastic deformation in the at least one coupled element;
(e) elastic deformation in the shaft; and
(f) combinations thereof.

34. The apparatus as claimed in any one of the above claims wherein the environment or a part thereof, about the at least one coupled element, imposes a pressure force on the non-shaft-interfacing surface regions of the at least one coupled element thereby increasing the clamping force of the at least one coupled element against the shaft.

35. The apparatus as claimed in any one of the above claims wherein the apparatus further comprises at least one clamping member that applies an external load on the at least one coupled element.

36. The apparatus as claimed in any one of claims 1 to 34 wherein the apparatus further comprises at least one clamping member wherein the at least one clamping member imposes a clamping force on the at least one coupled element and, at least partially indirectly, to the shaft through at least part of the at least one coupled element and shaft abutting surfaces.

37. The apparatus as claimed in claim 35 or claim 36 wherein coupling is imposed by a first and second clamping force, the first clamping force on the shaft being provided by a primary interference fit between the at least one coupled element and, the shaft and the second clamping force being provided by a secondary interference fit between the at least one clamping member and the at least one coupled element.

38. The apparatus as claimed in claim 35 or claim 36 wherein coupling is also provided by a friction fit between the at least one clamping member and the at least one coupled element.

39. The apparatus as claimed in any one of the above claims wherein the at least one coupled element has a taper shaped non-shaft facing surface.

40. The apparatus as claimed in claim 39 wherein the at least one coupled element taper extends from a first side of the at least one coupled element longitudinally towards the at least one coupled element centre and/or opposing second side transitioning to a larger cross-section area from the first side to the centre and/or second side of the at least one coupled element.

41. The apparatus as claimed in claim 39 or claim 40 wherein the taper on the at least one coupled element is axially aligned with the shaft axis.

42. The apparatus as claimed in any one of claims 39 to 41 wherein the at least one clamping member has an internal taper facing surface is substantially similar to the taper of the coupled element.

43. The apparatus as claimed in any one of claims 39 to 42 wherein the internal taper facing surface of the at least one clamping member mates with the at least one coupled element in a drive up process such that, at the point of first overlap of the at least one clamping member and the at least one coupled element, the at least one clamping member initially fits over the at least one coupled element without interference and, when the at least one clamping member is fully fitted to the taper of the at least one coupled element, an interference fit results.

44. The apparatus as claimed in claim 43 wherein, when fitted, the at least one clamping member provides a static radial clamping force between the at least one coupled element and the shaft.

45. The apparatus as claimed in any one of claims 35 to 44 wherein the at least one clamping member is mated with the at least one coupled element by methods selected from:
(a) heat to expand the at least one clamping member;
(b) cold to decrease the at least one coupled element size;
(c) hydrostatic pressure to provide a bearing system between the at least one coupled element and the shaft;
(d) elastic deformation in the at least one clamping member;
(e) elastic deformation in the at least one coupled element; and
(f) combinations thereof.

46. The apparatus as claimed in any one of claims 35 to 45 wherein the at least one clamping member is a collar.

47. The apparatus as claimed in any one of the above claims wherein the at least one clamping member is selected to be substantially heat conductive and to have the properties of:
(a) dimensional expansion rate on heating; and/or
(b) dimensional contraction rate on cooling.

48. The apparatus as claimed in any one of claims 35 to 47 wherein the environment or a part thereof about the at least one clamping member imposes a pressure force on the at least one clamping member thereby increasing the clamping force of the at least one clamping member against the at least one coupled element.

49. An apparatus comprising:
a shaft; and
at least one coupled element located about at least a region of the shaft longitudinal length;
wherein the at least one coupled element and the shaft are coupled to prevent relative movement between the shaft and at least one coupled element, coupling completed by a combination of:
(a) a clamping force imposed by at least one clamping member applying an external load on the at least one coupled element such that the at least one coupled element has an imposed interference fit between at least part of the at least one coupled element and the shaft; and
(b) a friction effect due to clamping about at least part of the at least one coupled element and the shaft facing surfaces.

50. A method of coupling a shaft and at least one coupled element by selecting at least one shaft and at least one coupled element and coupling the shaft and element or elements using the apparatus as claimed in any one of the above claims.

51. The apparatus as claimed in any one of claims 1 to 49 wherein the apparatus is used in a viscous damper.

52. The apparatus as claimed in any one of claims 1 to 49 wherein the apparatus is used in a hydraulic cylinder.
